(19) United States
(12) Patent Application Publication
(10) Pub. No.: US 2016/0357790 A1
(43) Pub. Date: Dec. 8, 2016

(54) RESOLVING AND MERGING DUPLICATE RECORDS USING MACHINE LEARNING

(71) Applicant: InsideSales.com, Inc., Provo, UT (US)

(72) Inventors: Dave Elkington, Springville, UT (US); Xinchuan Zeng, Orem, UT (US); Richard Morris, Sandy, UT (US)

(21) Appl. No.: 14/966,422

(22) Filed: Dec. 11, 2015

Related U.S. Application Data
(63) Continuation-in-part of application No. 13/838,339, filed on Mar. 15, 2013, now abandoned.
Application No. 13/838,339 is a continuation-in-part of application No. 14/625,923, filed on Feb. 19, 2015.
Application No. 14/625,923 is a continuation of application No. 13/590,000, filed on Aug. 20, 2012, now Pat. No. 8,812,417.
Application No. 13/590,000 is a continuation-in-part of application No. 14/625,945, filed on Feb. 19, 2015.
Application No. 14/625,945 is a continuation of application No. 13/590,028, filed on Aug. 20, 2012, now Pat. No. 8,352,389.
Application No. 13/590,028 is a continuation-in-part of application No. 14/189,669, filed on Feb. 25, 2014.
Application No. 14/189,669 is a continuation of application No. 13/725,653, filed on Dec. 21, 2012, now Pat. No. 8,788,439.

(51) Int. Cl. G06F 17/30; G06N 7/00; G06N 5/04; G06N 99/00

(52) U.S. Cl. CPC G06F 17/30303; G06N 99/005; G06N 7/005; G06N 5/048

(57) ABSTRACT

According to various embodiments of the present invention, an automated technique is implemented for resolving and merging fields accurately and reliably, given a set of duplicated records that represents a same entity. In at least one embodiment, a system is implemented that uses a machine learning (ML) method, to train a model from training data, and to learn from users how to efficiently resolve and merge fields. In at least one embodiment, the method of the present invention builds feature vectors as input for its ML method. In at least one embodiment, the system and method of the present invention apply Hierarchical Based Sequencing (HBS) and/or Multiple Output Relaxation (MOR) models in resolving and merging fields. Training data for the ML method can come from any suitable source or combination of sources.

### CROSS-REFERENCE TO RELATED APPLICATION

The present application claims priority as a continuation-in-part of U.S. Utility application Ser. No. 13/838,339 for “Resolving and Merging Duplicate Records Using Machine Learning”, (Atty. Docket No. INS001), filed Mar. 15, 2013, the disclosure of which is incorporated by reference herein.

The present application further claims priority as a continuation-in-part of U.S. Utility application Ser. No. 14/625,923 for “Hierarchical Based Sequencing Machine Learning Model”, filed Feb. 19, 2015, which claimed priority as a continuation of U.S. Utility application Ser. No. 13/590,000 for “Hierarchical Based Sequencing Machine Learning Model”, filed Aug. 20, 2012 and issued as U.S. Pat. No. 8,812,417 on Aug. 19, 2014. The disclosure of both of these applications is incorporated by reference herein.

The present application further claims priority as a continuation-in-part of U.S. Utility application Ser. No. 14/625,945 for “Multiple Output Relaxation Machine Learning Model”, filed Feb. 19, 2015, which claimed priority as a continuation of U.S. Utility application Ser. No. 13/590,028 for “Multiple Output Relaxation Machine Learning Model”, filed Aug. 20, 2012 and issued as U.S. Pat. No. 8,352,389 on Jan. 8, 2013. The disclosure of both of these applications is incorporated by reference herein.

The present application further claims priority as a continuation-in-part of U.S. Utility application Ser. No. 14/189,669 for “Instance Weighted Learning Machine Learning Model”, filed Feb. 25, 2014, which claimed priority as a continuation of U.S. Utility application Ser. No. 13/725,653 for “Instance Weighted Learning Machine Learning Model”, filed Dec. 21, 2012 and issued as U.S. Pat. No. 8,788,439 on Jul. 22, 2014. The disclosure of both of these applications is incorporated by reference herein.

### FIELD OF THE INVENTION

The present invention relates to techniques for automatically resolving and merging duplicate records in a set of records, using machine learning.

### DESCRIPTION OF THE RELATED ART

In any sizable set of records, it is possible to encounter duplicate records that represent the same entity. Such duplicate records can be the result of entry errors, data that comes from different sources, inconsistencies in data entry methodologies, and/or the like. One example of such a situation is a mailing list database; it is common for such a database to have duplicate records for the same person, for example if the person subscribed to the mailing list more than once.

Generally, the presence of duplicate records is undesirable, because it can lead to waste (e.g. sending several identical mailings to the same person), can degrade customer service, and can impede customer-tracking and data-collection efforts. Although many existing systems have the capability to identify matching records and eliminate duplicates, such systems may encounter difficulty when the duplicate records are not identical to one another. For example, a person may have entered a middle initial on one record and a full middle name on another; as another example, one or more errors may have been introduced during data entry of one of the records; as another example, a person may have moved or otherwise changed his or her information, so that one record reflects outdated information.

In such situations, it may be difficult to determine which data is correct, particularly when the data elements in various records are inconsistent with one another. In some cases, one record may contain correct information for some data fields, while another record may contain correct information for other data fields. For data sets that include large numbers of records, and/or including at least several fields for each record, the problem of resolving inconsistent data when merging records can be significant. Manual review of duplicate data records can be used, but such a technique is time-consuming and error-prone; furthermore, even with manual review, resolving inconsistent data can still involve significant amounts of guesswork.

The subject matter claimed herein is not limited to embodiments that solve any disadvantages or that operate only in environments such as those described above. Rather, this background is only provided to illustrate one example technology area where some embodiments described herein may be practiced.

### SUMMARY

According to various embodiments of the present invention, an automated technique is implemented for resolving and merging fields accurately and reliably, given a set of duplicated records representing the same entity. In at least one embodiment, the task of resolving and merging fields involves a problem of determining multiple interdependent outputs simultaneously; specifically, multiple fields (to be resolved) are interdependent, in that the resolution of one field can have an impact on the resolution of other fields. Such problems are more complicated than most problems in which each output can be determined independently, using only the inputs.

In at least one embodiment, a system is implemented that uses a machine learning (ML) method, to train a model from training data, and to learn from users how to efficiently resolve and merge fields. In at least one embodiment, the method of the present invention builds feature vectors as input for its ML method.

In at least one embodiment, the system and method of the present invention apply Hierarchical Based Sequencing (HBS) and/or Multiple Output Relaxation (MOR) models, as described in the above-referenced related patent applications, in resolving and merging fields.

Training data for the ML method can come from any suitable source or combination of sources. For example, in various embodiments, training data can be generated from any or all of: historical data; user labeling; a rule-based method; and/or the like. When user labeling is used, a labeling confidence score can be assigned, and an Instance Weighted Learning (IWL) method can be used for training classifiers based on the labeling confidence scores.

Further details and variations are described herein.

### BRIEF DESCRIPTION OF THE DRAWINGS

The accompanying drawings illustrate several embodiments of the invention. Together with the description, they serve to explain the principles of the invention according to the embodiments. One skilled in the art will recognize that the particular embodiments illustrated in the drawings are merely exemplary, and are not intended to limit the scope of the present invention.

FIG. 1A is a block diagram depicting a hardware architecture for practicing the present invention according to one embodiment of the present invention.

FIG. 1B is a block diagram depicting a hardware architecture for practicing the present invention in a client/server environment, according to one embodiment of the present invention.

FIG. 2 is a flowchart depicting a method of resolving duplicates using Machine Learning (ML), according to one embodiment of the present invention.

FIG. 3 is a flowchart depicting a method of building training data and training ML models, according to one embodiment of the present invention.

FIG. 4 is an example of a set of duplicated records.

FIG. 5 is an example of a set of feature vectors that may be calculated from duplicated records, according to one embodiment of the present invention.

FIG. 6 is an example of generating resolved records from feature vectors, according to one embodiment of the present invention.

### DETAILED DESCRIPTION OF THE EMBODIMENTS

### System Architecture

According to various embodiments, the present invention can be implemented on any electronic device equipped to receive, store, transmit, and/or present data, including data records in a database. Such an electronic device may be, for example, a desktop computer, laptop computer, smartphone, tablet computer, or the like.

Although the invention is described herein in connection with an implementation in a computer, one skilled in the art will recognize that the techniques of the present invention can be implemented in other contexts, and indeed in any suitable device capable of receiving, storing, transmitting, and/or presenting data, including data records in a database. Accordingly, the following description is intended to illustrate various embodiments of the invention by way of example, rather than to limit the scope of the claimed invention.

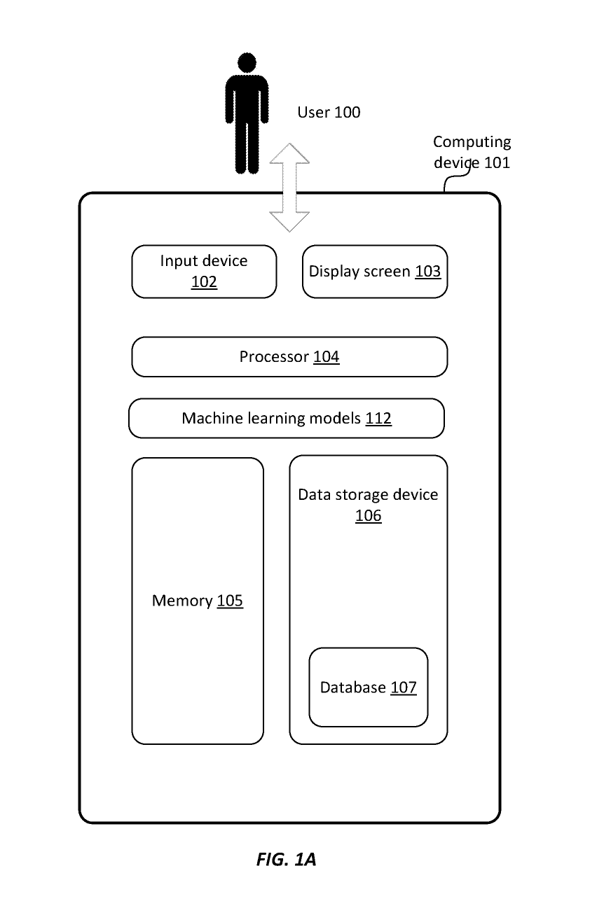

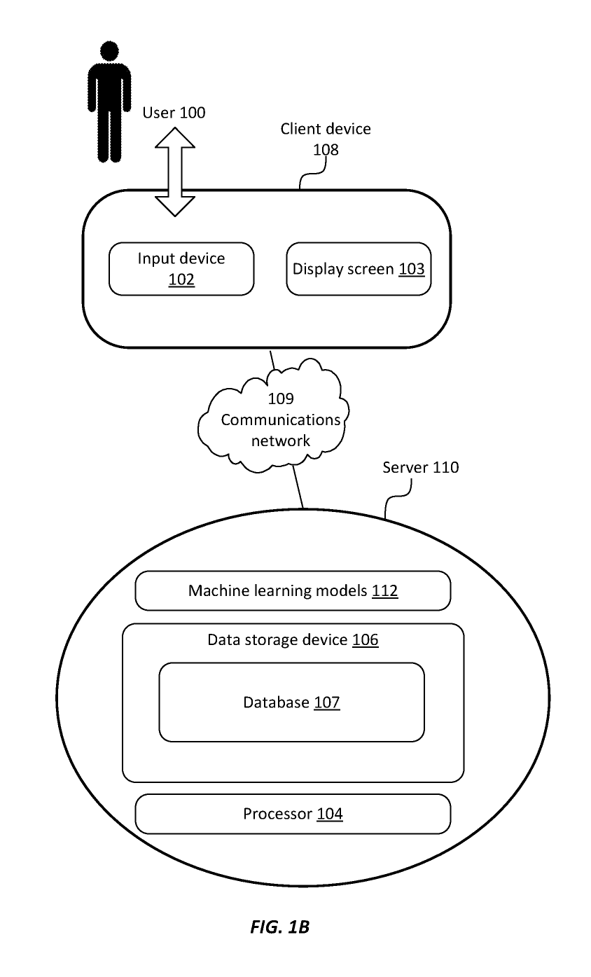

Referring now to FIG. 1A, there is shown a block diagram depicting a hardware architecture for practicing the present invention, according to one embodiment. Such an architecture can be used, for example, for implementing the techniques of the present invention in a computer or other device 101. Device 101 may be any electronic device equipped to receive, store, transmit, and/or present data, including data records in a database, and to receive user input in connect with such data.

In at least one embodiment, device 101 has a number of hardware components well known to those skilled in the art. Input device 102 can be any element that receives input from user 100, including, for example, a keyboard, mouse, stylus, touch-sensitive screen (touchscreen), touchpad, trackball, accelerometer, five-way switch, microphone, or the like. Input can be provided via any suitable mode, including for example, one or more of: pointing, tapping, typing, dragging, and/or speech.

Display screen 103 can be any element that graphically displays a user interface and/or data.

Processor 104 can be a conventional microprocessor for performing operations on data under the direction of software, according to well-known techniques. Memory 105 can be random-access memory, having a structure and architecture as are known in the art, for use by processor 104 in the course of running software.

Data storage device 106 can be any magnetic, optical, or electronic storage device for storing data in digital form; examples include flash memory, magnetic hard drive, CD-ROM, DVD-ROM, or the like.

Data storage device 106 can be local or remote with respect to the other components of device 101. In at least one embodiment, data storage device 106 is detachable in the form of a CD-ROM, DVD, flash drive, USB hard drive, or the like. In another embodiment, data storage device 106 is fixed within device 101. In at least one embodiment, device 101 is configured to retrieve data from a remote data storage device when needed. Such communication between device 101 and other components can take place wirelessly, by Ethernet connection, via a computing network such as the Internet, or by any other appropriate means. This communication with other electronic devices is provided as an example and is not necessary to practice the invention.

In at least one embodiment, data storage device 106 includes database 107, which may operate according to any known technique for implementing databases. For example, database 107 may contain any number of tables having defined sets of fields; each table can in turn contain a plurality of records, wherein each record includes values for some or all of the defined fields. Database 107 may be organized according to any known technique; for example, it may be a relational database, flat database, or any other type of database as is suitable for the present invention and as may be known in the art. Data stored in database 107 can come from any suitable source, including user input, machine input, retrieval from a local or remote storage location, transmission via a network, and/or the like.

In at least one embodiment, machine learning (ML) models 112 are provided, for use by processor in resolving duplicate records according to the techniques described herein. ML models 112 can be stored in data storage device 106 or at any other suitable location. Additional details concerning the generation, development, structure, and use of ML models 112 are provided herein.

Referring now to FIG. 1B, there is shown a block diagram depicting a hardware architecture for practicing the present invention in a client/server environment, according to one embodiment of the present invention. An example of such a client/server environment is a web-based implementation, wherein client device 108 runs a browser that provides a user interface for interacting with web pages and/or other web-based resources from server 110. Data from database 107 can be presented on display screen 103 of client device 108, for example as part of such web pages and/or other web-based resources, using known protocols and languages such as HyperText Markup Language (HTML), Java, JavaScript, and the like.

Client device 108 can be any electronic device incorporating input device 102 and display screen 103, such as a desktop computer, laptop computer, personal digital assistant (PDA), cellular telephone, smartphone, music player, handheld computer, tablet computer, kiosk, game system, or the like. Any suitable communications network 109, such as the Internet, can be used as the mechanism for transmitting data between client 108 and server 110, according to any suitable protocols and techniques. In addition to the Internet, other examples include cellular telephone networks, EDGE, 3G, 4G, long term evolution (LTE), Session Initiation Protocol (SIP), Short Message Peer-to-Peer protocol (SMPP), SS7, WiFi, Bluetooth, ZigBee, Hypertext Transfer Protocol (HTTP), Secure Hypertext Transfer Protocol (SHTTP), Transmission Control Protocol/Internet Protocol (TCP/IP), and/or the like, and/or any combination thereof. In at least one embodiment, client device 108 transmits requests for data via communications network 109, and receives responses from server 110 containing the requested data.

In this implementation, server 110 is responsible for data storage and processing, and incorporates data storage device 106 including database 107 that may be structured as described above in connection with FIG. 1A. Server 110 may include additional components as needed for retrieving and/or manipulating data in data storage device 106 in response to requests from client device 108. In at least one embodiment, machine learning (ML) models 112 are provided, for use by processor in resolving duplicate records according to the techniques described herein. ML models 112 can be stored in data storage device 106 of server 110, or at client device 108, or at any other suitable location.

### Overall Method

In general, the task performed by the system and method of the present invention can be formulated as follows.

Let S be a set of duplicates S={s₁, s₂, . . . sᵢ, . . . s_{N}} (i=1, . . . N). The set S has N records which represent the same entity. This set may be generated, for example, by a de-duplication tool, as is known in the art, which has the capability of identifying duplicated records from a data set. Many such de-duplication tools are known, including record-linkage algorithms that are configured to find records in a data set that refer to the same entity across different data sources. For example, see W. E. Yancey, “BigMatch: A Program for Large-Scale Record Linkage,” Proceedings of the Section on Survey Research Methods, American Statistical Association (2004).

Each duplicate sᵢ (i=1, . . . N) has m fields sᵢ=s_{(i,1)}, s_{(i,2)}, . . . , s_{(i,j)} . . . s_{(i,M)}). (j=1, . . . M).

Once the duplicate records have been resolved (using the techniques described herein), the output of the system and method of the present invention is a resolved entity sᵣ=s_{(i,1)}, s_{(i,2)}, . . . , s_{(i,M)} with a high reliability. Each field s_{(r,j)} (j=1, . . . M) of the resolved entity is be derived from N duplicates of that field s_{(i,j)} (i=1, . . . N).

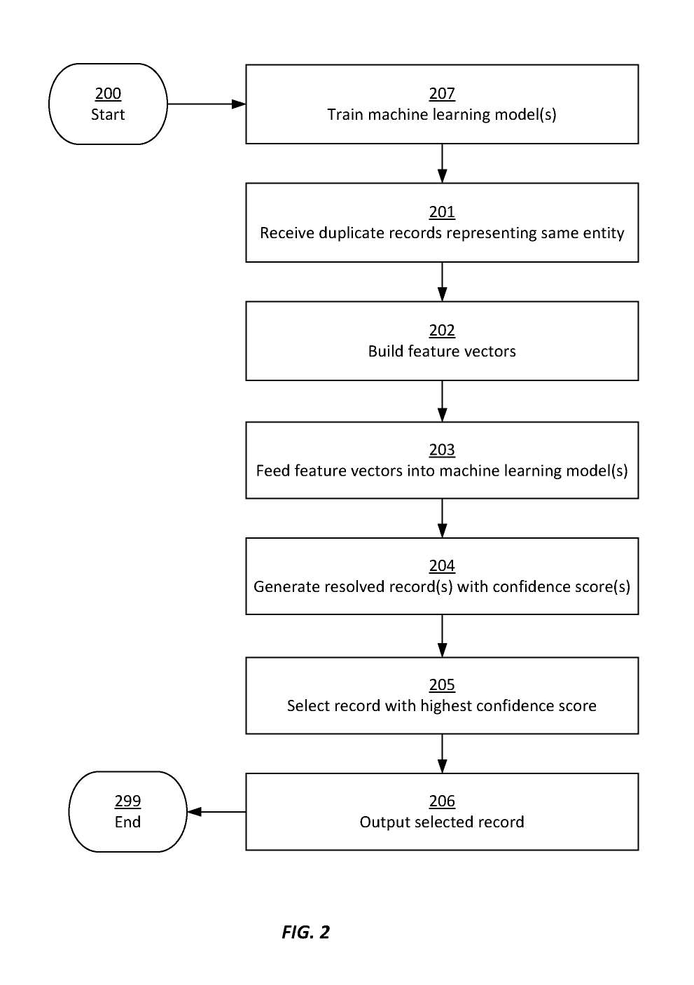

Referring now to FIG. 2, there is shown a flowchart depicting a method of resolving duplicates using Machine Learning (ML), according to one embodiment of the present invention. In at least one embodiment, the steps of FIG. 2 are performed by processor 104 at computing device 101 or at server 110, although one skilled in the art will recognize that the steps can be performed by any suitable component.

The method begins 200. As an initial step, ML model(s) include classifiers that are trained 207 using training data, as describe in more detail herein. Training data can be collected and generated from historical data, user-labeled data and/or a rule-based method.

Once ML model(s) is/are trained 207, they are ready for use in generating predictions. Input is received 201, including N duplicate records representing the same entity. Feature vectors are built 202 for each of the N duplicate records. In general, a feature vector is a collection of features, or characteristics, of records; these features are then used (as described below) in resolving duplicates. Any suitable features of records can be used in generating feature vectors. In at least one embodiment, the system of the present invention selects those features that are indicative of the reliability of a record.

Once feature vectors have been built 202, the feature vectors are fed 203 into ML model(s) 112, which generate 204 one or more resolved records. In at least one embodiment, a confidence score is associated with each generated resolved record. The record with the highest confidence score is selected 205 and output 206.

Alternatively, the user can be presented with multiple resolved records, and prompted to select one. In yet another embodiment, the user can be presented with scores for candidate values of individual fields, and prompted to select values for each field separately; a resolved record is then generated using the user selections. Further details of these methods are provided below.

### Feature Vectors

As described above, in step 202 of FIG. 2, feature vectors are built for each of the N duplicate records. For example, for record sᵢ, Feat(sᵢ)=(Feat(i,1), . . . Feat_{(i,k)}) represents the feature vector to be built (which has K features).

The feature vector can be built from any suitable combination of components. One example of a feature vector is Feat={Feat(Completeness), Feat(Source_Quality), Feat(Field_Validity), Feat(Voting), Feat(Similarity), Feat(Freq), Feat(Recency), Feat(Consistency)}. The components found in this example are described in more detail below.

The following is a representative list of example features that can be used in building feature vectors; one skilled in the art will recognize, however, that any suitable features can be used.

### Completeness of Record

In general, a record with a high degree of completeness is more reliable than a record with a large number of missing values. Thus, in at least one embodiment, completeness can be used as a feature to estimate the reliability of a record.

In at least one embodiment, completeness of a record is calculated based on the number of fields that have a value (not empty) as compared with the total number of fields. Completeness can thus be defined as

Feat(Completeness)=<number of fields with value>/<total number of fields>

For example, if a record has 10 fields, Record={last_name, first_name, email, home_phone, mobile_phone, zip_code, company_name, title, industry, website}. If all fields of a record have values except website, then the completeness of the record would be 9/10, or 90%.

### Quality of Record Source

The reliability of a record is usually dependent on the quality of the source from which the record was obtained.

For example, for databases that are used in lead response management (LRM), records of leads may come from different sources, such as web forms filled by leads, trade shows, company websites, search engines, inbound calls from leads to sales reps, outbound calls from sales reps to leads, customer referrals, and the like. For example, a record from the source of customer referrals may be more reliable than a record from the source of a filled web form.

For a given source “src”, the feature can be calculated using a function such as Feat(Source_Quality)=Quality(src), where Quality(src) is the quality of source “src”. An estimation of the quality of a source “src” may be derived by any suitable means, such as for example manually by experts with extensive knowledge on the quality of all sources. Alternatively, the quality can also be derived based on statistics of historical data (analyzing correlation between resolved data and record source in order to estimate quality of source). In at least one embodiment, quality has a value in the range [0,1] with 1 being highest quality.

### Validity

In at least one embodiment, the system of the present invention checks whether a field has a valid value. For example, a “city” field is considered valid only if the city exists. A similar approach can also be applied to check validity of ZIP codes, telephone numbers, social security numbers, and the like. In at least one embodiment, the corresponding feature Feat(Field_Validity) can be represented by a binary value of 1 (valid) or 0 (invalid).

### Voting Score

A field value can be considered more reliable if it appears more frequently (among duplicate records) than do other values. For example, consider a case of five duplicates of a record that includes a first name field. If three of the duplicates have the first name of “John” and the other two duplicates have the first name of “Jonathan”, the voting score for “John” is 3/5=0.6, and voting score for “Jonathan” is 2/5=0.4.

In general, a voting feature can be represented as Feat(Voting)=<number of repeats>/<total duplicates>.

### Similarity to Centroid

A centroid record can be derived from duplicate records. The centroid record is a record that minimizes the overall distance to all of the duplicate records.

If dist(i,j) is the distance between records i and j, a centroid can be defined as centroid=ArgMin(dist(i,j)) (where i, j=1, 2, . . . N). For example, if five duplicate records are identified, containing the first names “John”, “John”, “Johnathan”, “Jonathan”, and “Jeff”, then “John” is selected as the centroid record since it has minimum distance between all pairs among those values.

In at least one embodiment, the distance metric dist(i,j) is calculated using a hybrid of both Euclidean distance and edit/keyboard distances. Euclidean distance can be measured as a straight-line distance, in n-dimensional space; given two vectors p and q it can be described as the square-root of (p₁−q₁)²+(p₂−q²)²+ . . . +(pₙ−qₙ)². Edit/keyboard distance is a measure of how many characters are changed from one value to another, and can also take into account the distance between keys corresponding to those changed characters on a (real or virtual) QWERTY keyboard.

In at least one embodiment, each distance from a field to the centroid's field can be weighted by the field quality. For example, each field can be assigned a field quality score within the range [0,1], based on any suitable factor(s), such as for example, the confidence of the person entering the data, the quality of the source, and the like. In at least one embodiment, the source can be tracked separately for each field. Using this field quality, a modified distance score is determined, for example by multiplying the distance by the field quality. In at least one embodiment, fields are treated differently based on the range of valid values.

The following are examples of how different types of fields can be handled.
For strings: Use keyboard or edit distance.
For fields that can be normalized, such as Company, Address, or Title Fields: Use keyboard or edit distance on a normalized version of the field.
For numerical fields: Calculate a Euclidean distance from the numeric values.
For e-mail fields: Check to see if the domains match (unless both are common domain names such as gmail.com).

For each record i, let dist(i, c) be the distance between record i and the centroid record. In at least one embodiment, dist(i, c) can be normalized to a real value in the range [0,1]. For example, a scale parameter can be set, based on which distance metrics are being used. Dist (i, c) can then be normalized by calculating dist(i, c)/scale if dist(i, c)<=scale, or setting dist(i, c) to 1.0 if dist(i, c)>scale.

A similarity feature value can then be calculated by feat(Similarity)=(1.0−dist(i, c)).

### Frequency Score

In at least one embodiment, a frequency score is used, which measures how often a particular data value appears in a frequency table. In at least one embodiment, if the value (for example a first name) appears in a frequency table, and has a frequency exceeding some threshold, then the frequency feature value is set to 1; otherwise it is set to some value that is less than 1. For example, a first name can be compared to a frequency table for first name. If a first name can be found in the table and its frequency is above a threshold, then the frequency feature value is set to 1 for frequency score. If the frequency of the first name is at or below the threshold, it receives a frequency score of <Freq>/<Threshold>.

### Recency Score

In at least one embodiment, a recency score is used, which measures how recently the field was updated. In general, a more recently updated field is more reliable.

In at least one embodiment, a value for Feat(Recency) can be calculated based on the date of update. For example, it can be assigned a value in the range [0,1]. A value of 1 is assigned to the field with the most recent updated field, and a value of 0 is assigned to the field with the least recently updated field. For a field between the two cases, score can be calculated by Feat(Recency)=(t2−t)/(t2−t1) where t1 is the most recent time and t2 is the least recent time. Any other suitable technique can be used for assigning a recency score.

### Internal Consistency Score

In at least one embodiment, an internal consistency score is used, to measure how consistent a given field is with other fields. For example, a particular value for a city name field should be consistent with a ZIP code field. Greater levels of consistency indicate more reliable records.

In at least one embodiment, a consistency value can be calculated as Feat(Consistency)=<number of consistencies>/(<total number of fields>−1). The number of consistencies can be measured using any suitable technique, such as by determining how many fields are consistent with other fields. The value of Feat(Consistency) is in the range [0,1], with a score of 1 indicating the highest possible level of consistency.

### Other Potential Features

One skilled in the art will recognize that the above list of features is merely exemplary. Features can be used in any suitable combination. Other features than those listed above can be used. Examples of other features are:
For an application related to lead response management (LRM), a feature value can be established to indicate that the field has been used to successfully contact the lead. For example, a feature value of phone_contacted, can be set to 1 if the ith duplicate's phone number has been used successfully to contact the lead. Other similar features can be used, such as email_contacted, and the like.
In at least one embodiment, a feature value can indicate recency since the record was edited, expressed for example as the length of time since the most recent edit. Separate values can be measured for each field in the record.
In at least one embodiment, a feature value can indicate which representative created and/or edited the record. The quality of records created/edited by different representatives may vary, for example, based on length of experience or record of past performance; thus this feature may be predictive of the overall reliability of the record.
In at least one embodiment, a feature value can indicate the number of results from a search engine for a company name, person name and title, and/or the like.
In at least one embodiment, a feature value can indicate social media information for a specific person or entity. For example, the number of followers can be used.

### Training Machine Learning Model

In at least one embodiment, classifiers of ML model 112 are initially trained based on training data from historical records, to learn how to efficiently resolve/merge fields. Training data can be collected and generated from historical data, in which unlabeled data can be labeled, based for example on user input and/or rule-based labeling. Such training can take place using any known techniques for training machine learning models, as may be known in the art. For example, such training can proceed by generating resolved records using ML model 112, comparing such results against results obtained by other means, and making adjustments to ML model 112 by feedback of the independently obtained results (such as by confirmed records or by user-labeled data). In general, any traditional machine learning algorithms (such as MLP trained with back-propagation, decision trees, support vector machine, and the like) can be applied to train and maintain ML model 112. In at least one embodiment, training is ongoing, by continuing to provide feedback to make further adjustments to ML model 112 based on selections made by the user or based on other input.

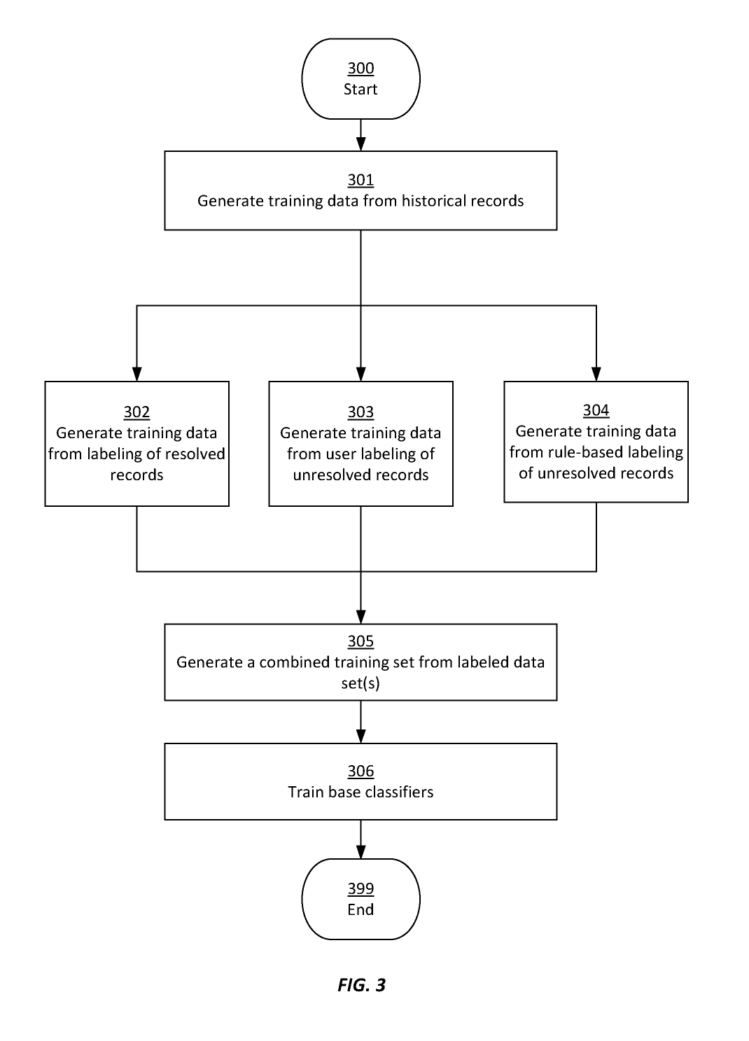

Referring now to FIG. 3, there is shown a flowchart depicting a method of building training data and training ML model(s) 112, according to one embodiment of the present invention. The method of FIG. 3 depicts a combination of training methodologies, although one skilled in the art will recognize that any number of training methodologies can be used, either singly or in combination with one another.

The method begins 300. In steps 301, 302, 303, and 304, respectively, training data is generated from any one or more of:
historical records;
labeling of resolved records;
user labeling of unresolved records; and/or
rule-based labeling of unresolved records.

For illustrative purposes, as shown in FIG. 3, in at least one embodiment, step 301 is performed, followed by one of 302, 303 or 304; however, any or all of these steps can be performed in any suitable sequence.

A combined training set is then generated 305 from the labeled data set(s), and base classifiers are trained 306. The result is a set of base classifiers that can be used for future predictions.

Various steps of FIG. 3 are described in more detail below. Generate Training Data from Historical Data 301

In at least one embodiment, training data is generated 301 from historical data as follows. From a historical data set, the system identifies all entries that have at least two duplicates in the historical data for a particular entity, for which a resolved record has been identified in the most recent duplicate set. An assumption is made that the resolution has been confirmed with a high degree of confidence.

For a given entity, let {S₁, S₂, . . . S_{T}} be the sequence of data at different times t=1, 2, . . . , T, where t is incremented by one whenever there is an update (such as adding a duplicate, update a field on a record, etc.) on the data set. Let S_{T} be the most recent duplicate set and let s_{(T,r)} be the resolved record in S_{T}.

Using this data, T training instances can be generated as follows:
Use S₁ as input and use resolved record s_{(T,r)} as the training target.
Use S₂ as input and use resolved record s_{(T,r)} as the training target.
. . .
Use S_{T} as input and use resolved record s_{(T,r)} as the training target.
When using labeled resolved record s_{(T,r)} to set target value for training MLPₖ for field k, set the training target of the output node i of MLPₖ to 1 if field k of record i (among N duplicates in a set) is same as the field k in labeled resolved record resolved field s_{(T,r)}; otherwise, set the training target to 0.

In this manner, multiple training instances can be generated for each sequence with duplicates in the historical data and that has a resolved record.

Generate Training Data from Labeling of Resolved Records 302

In the training data generated from historical data is step 301, some records may have been confirmed with higher confidence than other records. For example, if a phone number or email has been used to contact a lead, then that information has increased reliability, and the phone number or email can be considered “resolved”. Training date can then be generated using these resolved fields.

In at least one embodiment, it is possible that in a particular record, some fields are resolved while other fields are not resolved. In this case, training data can be generated from resolved fields, while other fields can be handled using steps 303 and/or 304, as described below.

Generate Training Data from User Labeling 303

For a data sequence (for a fixed entity), if there are at least two duplicates in the historical data for this entity, but there is no resolved record, training data can be generated 303 by user labeling.

For some duplicates, it may be difficult for a user to generate a resolved record with high confidence. Thus, in at least one embodiment, a vector of confidence scores is assigned for each record resolved by user labeling.

For example, if sᵣ=(s_{(r,1)}, s_{(r,2)}, . . . , s_{(r,M)}) is a record resolved by user labeling, a labeling confidence score vector Label_Conf_Score={lcs₁, lcs₂, . . . , lcs_{M}} can be generated to associate with the resolved record sᵣ, where lcsᵢ is the labeling confidence score for field i. In at least one embodiment, the confidence score is in the range [0,1] with 1 being most confident.

In at least one embodiment, sᵣ=(s_{(r,1)}, s_{(r,2)}, . . . , s_{(r,m)}) can be assigned to (1, 1, . . . 1) by default. If the confidence level is sufficiently high, these values may be left as-is.

Any suitable method can be used for providing confidence levels. For example, in at least one embodiment, a user can input a numeric score (or other score) indicating a confidence level. Any suitable range or scale can be used, such as for example:
a number between 1-100;
a number between 1-5 or 1-10, which can be mapped internally to a 1-100 or other desired scale;
a graphical scale, such as different faces, different colors, or the like, which can be mapped internally to a 1-100 or other desired scale;
a text-based scale, such as {very low confidence, low confidence, neutral, high confidence, very high confidence}, which can be mapped internally to a 1-100 or other desired scale.

In at least one embodiment, training step 306 takes into account the confidence score that is received or determined during labeling by a user. Those labeled instances having higher confidence scores are weighted more heavily than those with lower confidence scores. In at least one embodiment, an Instance Weighted Learning (IWL) method, as described in related U.S. Utility application Ser. No. 13/725,653 for “Instance Weighted Learning Machine Learning Model”, filed Dec. 21, 2012, the disclosure of which is incorporated by reference herein, is applied to use labeling confidence score as a quality value for training. As described in the related application, the quality value is employed to weight the corresponding training instance so that the classifier learns more from a training instance with a higher quality value than from a training instance with a lower quality value.

When users manually merge data, it may be useful to collect information as to the reason or justification for the merge. Such data can be used for metadata to help ML model 112 learn more effectively and make better decisions. In at least one embodiment, the set of provided reasons, or some subset thereof, can be used as one of the input features for the ML algorithm described above.

Users may make decisions based on many different factors, such as for example selecting the newest record, the oldest record, source reliability, consistency with another field, voting among duplicated records, and the like. In at least one embodiment, the user can be prompted to provide input to explain or justify the merge. In at least one embodiment, a set of predefined reasons can be provided as a drop-down menu, for selection by the user.

In at least one embodiment, the system of the present invention tracks, in a history log, all modifications and updates to records. This allows previous values to be restored, if needed, for example in case a user wishes to restore a value in a record to a previous value. A history log can also be helpful to build training data for ML models 112.

In at least one embodiment, the retained history log also includes detailed information based on input provided during user labeling, so that the algorithm can have more detailed information for learning. In at least one embodiment, each record's field-by-field history can be tracked, as well as the history of the record as a whole, to indicate merging and modifying of fields. Keeping field-by-field history is useful to allow ML models 112 to learn how to make decisions on merging fields. It can also help to keep track of other useful information, such as field-by-field original source and compliance with usage agreements.

Generate Training Data from Rule-Based Labeling Method 304

For a data sequence (for a fixed entity), if there are at least two duplicates in the historical data for this entity, but there is no resolved record, training data can be generated 304 by a rule-based method. Such a method is particularly useful for those duplicates that are relatively easy to label with rules. For more complex cases, user labeling (as described above) may be more effective to attain reliable results.

One example rule-based labeling method is the generation of a resolved record using a centroid record derived from duplicate records, as described above.

In at least one embodiment, a labeling confidence score vector Label_Conf_Score={lcs₁, lcs₂, . . . , lcs_{M}} is generated and associated with the resolved record sᵣ. When a centroid method is used, the confidence score vector can be calculated based on ranking score among all dist(i,j) other than the one with minimum distance. For example, a labeling confidence score is larger when the difference between the top result and the second result is larger, since this means it is easier to make the decision to choose between the top result and the second result as a resolved result. Conversely, the labeling confidence score is smaller when the difference between the top result and the second result is smaller, since this means it is more difficult to make the decision to choose between the top result and the second result as a resolved result.

In at least one embodiment, a threshold (such as 0.9) can be specified, so that only those rule-generated training data with high confidence scores are used.

### Application of Machine Learning Model

As described above, in at least one embodiment, an ML-based approach is used for selecting among data in duplicate records. In many cases, the various fields of the data records are interdependent, making this task too complex to use a conventional rule-based approach to achieve optimal solutions. An ML-based approach, as used by at least one embodiment of the present invention, has the advantage of learning to form optimal decision boundaries/rules in high-dimensional feature space.

Once a feature vector has been constructed 202 for each of the duplicate records in a set S of duplicates that represents a same entity, the feature vectors Feat(S) are fed 203 into ML model 112 (which has been previously trained) to generate 204 resolved record(s).

Using Feat(S) as input, ML model 112 generates 204 a list of one or more resolved solutions (with ranked confidence scores):
s[r₁]=(s[r₁,1], s[r₁,2], . . . , s[r₁,M]) (Solution [1], Confidence Score [1])
s[r₂]=(s[r₂,1], s[r₂,2], . . . , s[r₂,M]) (Solution [2], Confidence Score [2])
. . .
s[r_{N}]=(s[r_{N},1], s[r_{N},2], . . . , s[r_{N},M]) (Solution [N], Confidence Score [N])

In at least one embodiment, the top solution s[r₁] is automatically selected 205 as the final resolved solution for output 206. In another embodiment, some number of solutions (such as the top 5 solutions) may be output 206, so as to allow a user to inspect and analyze the results, particularly when several solutions have similar confidence scores. In at least one embodiment, the user's selections are fed back into ML model 112 for further adjustment and training of ML model 112.

In at least one embodiment, ML model 112 builds a sequence of classifiers for each field, and then combines predictions of each classifier to make final decisions as to which solution(s) to select. Any suitable type of classifier can be used. One example of a base classifier that can be used in connection with the present invention is a feedforward artificial neural network such as a multilayer perceptron (MLP); however, one skilled in the art will recognize that any other suitable ML classifier(s) can be used, such as decision trees, support vector machines, and/or the like.

### Prediction for Each Field by Base Classifier

In at least one embodiment, generation 204 of resolved records is performed as follows. Each base classifier attempts to make a reliable prediction on ranking score for a field among N duplicates in set S (using feature vector Feat(S) derived from S in step 202 as described above).

For the example of using an MLP as a base classifier (denoted as MLP(j)) for each field j, if there are N=5 duplicates, each MLP will have 5 output nodes. A real-valued vector y=(y₁, . . . y₅) is output, which reflects relative rankings predicted by the MLP.

If there are M fields, M MLP's will be trained to predict all M fields. For example, MLP(phone) will predict rankings for field “phone”; MLP(email) will predict rankings for field “email”, and the like.

### Composite Classifier for All Fields

As discussed above, selecting from among available data for all fields in a record is a complex learning problem with interdependent variables. For example, when a particular email address is selected from among email addresses in duplicate records, that selection may have an impact on which company name should be selected, since the domain of the email address should be consistent with company name. Similarly, when a particular ZIP code is selected, that selection may have an impact on a city name or telephone area code (if a landline).

Optimizing each field independently and then adding them together may not necessarily generate an optimized overall record. For example, some fields may not be consistent with each other even though each individual field is the optimal value independently. Accordingly, in at least one embodiment, ML model 112 generates an overall optimal record based on combined decisions from component classifiers.

In at least one embodiment, ML model 112 uses Hierarchical Based Sequencing (HBS), as described in related U.S. Utility application Ser. No. 13/590,000 for “Hierarchical Based Sequencing Machine Learning Model”, filed—Aug. 20, 2012, the disclosure of which is incorporated by reference herein, in its entirety. In at least one other embodiment, ML model 112 uses Multiple Output Relaxation (MOR), as described in related U.S. Utility application Ser. No. 13/725,653 for “Instance Weighted Learning Machine Learning Model”, filed Dec. 21, 2012, the disclosure of which is incorporated by reference herein, in its entirety. Either of these algorithms, or a combination thereof, can be used to make a combined decision based on decisions from individual classifiers.

### Hierarchical Based Sequencing (HBS)

As described in the above-cited related U.S. Utility Patent Application, a HBS machine learning model 112 can be used to predict multiple interdependent output components of an ML problem, by selecting a sequence for the multiple interdependent output components. Then, a classifier for each component is sequentially trained, in the selected sequence, to predict the component based on an input and on any previously predicted component(s). The selection of a sequence can be based on any suitable factor, or can be pre-set, or can be determined based on some assessment of which components are more likely to be more dependent on other components.

Thus, for example, let z=(z₁, . . . z_{N}) be the prediction vector to be made for N fields. HBS machine learning model 112 trains N classifiers as follows:

$${z}_{1} = {MLP}_{1} ( x ) ;$$

$${z}_{2} = {MLP}_{2} ( x , {z}_{1} ) ;$$

$${z}_{3} = {MLP}_{3} ( x , {z}_{1} , {z}_{2} ) ;$$

$$…$$

$${z}_{N} = {MLP}_{N} ( x , {z}_{1} , … , {z}_{N - 1} ) ;$$

where x is the input feature vector x=Feat(S) as described above.

Feature vector x is used as input for MLP₁ to predict output z₁. To predict output z₂, a combination of feature vector x as well as output z₁ from MLP₁) are used as input for MLP₂; this is indicated as (x,z₁). To predict output z₃, a combination of feature vector x as well as output z₁ from MLP₁ and output z₂ from MLP₂) are used as input for MLP₃; this is indicated as (x,z₁,z₂). In this manner, HBS machine learning model 112 is capable of capturing interdependency among multiple outputs.

In at least one embodiment, different HBS machine learning models 112 can be trained with different sequences on z₁, z₂, . . . z_{N}, and a particular model 112 can be selected based on a determination of which fields are more or less likely to be reliable. For example, one model M1 may set the sequence as z₁=phone number, z₂=zip_code, and the like. Another model M2 may set the sequence z₁=zip_code, z₂=phone_number, and the like. For a particular set of duplicates, if the phone_number is more reliable than the zip_code, model M1 is selected. If the zip_code is more reliable than the phone_number, then model M2 is selected. Different HBS models can be trained with different sequences based, for example, on the most common cases occurring in the training data.

### Multiple Output Relaxation (MOR)

As described in the above-cited related U.S. Utility Patent Application, an MOR machine learning model 112 can be used to predict multiple interdependent output components of an ML problem, by initializing each possible value for each of the components to a predetermined output value. Relaxation iterations are then run on each of the classifiers to update output values until a relaxation state reaches equilibrium, or until a pre-defined number of relaxation iterations have taken place. Other variations are described in the above-cited related U.S. Utility Patent Application.

Thus, for example, let z=(z₁, . . . z_{N}) be the prediction vector to be made for N fields. MOR machine learning model 112 trains N classifiers as follows:

$${z}_{1} = {MLP}_{1} ( x , {z}_{2} , {z}_{3} , … , {z}_{N} ) ;$$

$${z}_{2} = {MLP}_{1} ( x , {z}_{1} , {z}_{3} , … , {z}_{N} ) ;$$

$${z}_{3} = {MLP}_{1} ( x , {z}_{1} , {z}_{2} , {z}_{4} … {z}_{N} ) ;$$

$$…$$

$${z}_{N - 1} = {MLP}_{1} ( x , {z}_{1} , {z}_{2} , … , {z}_{N - 2} , {z}_{N} ) ;$$

$${z}_{N} = {MLP}_{1} ( x , {z}_{1} , {z}_{2} , … , {z}_{N - 1} ) ;$$

where x is the input feature vector x=Feat(S) as described above.

MLP₁ uses (x, z₂, z₃, . . . z_{N}) (feature vector x and all outputs from all other (N−1) MLP's) as inputs to predict output z₁. MLP₂ uses (x, z₁, z₃, . . . z_{N}) (feature vector x and all outputs from all other (N−1) MLP's) as inputs to predict output z₂. In general, each MLP uses feature vector x and all outputs from all other (N1) MLP's. A relaxation method is used to update z=(z₁, . . . z_{N}) at each iteration. In at least one embodiment, a relaxation rate (such as 0.1) is used to control relaxation process for a smoother process. When the relaxation process reaches equilibrium, the converged solutions can be retrieved.

In at least one embodiment, there is no need to predetermine the order of the sequence. Each classifier receives outputs from all other (N−1) classifiers as input for each iteration. The relaxation mechanism allows ML model 112 to converge to a solution.

### ML Model Output

In step 204 of FIG. 2, ML model 112 generates resolved record(s) with confidence scores. These resolved record(s) form a recommended merging solution. In at least one embodiment, a user can select one of a plurality of these generated records; in another embodiment, the system itself can make the selection.

In at least one embodiment, a threshold value can be set, either by the user or by some other entity. When the confidence score for a resolved record exceeds this threshold value, the field is automatically merged using the recommended solution specified by that resolved record, without user intervention. When the confidence score does not exceed the threshold value, the user can be prompted to manually merge the fields and/or to select among a plurality of generated records representing different solutions.

In at least one embodiment, the user selects values for each field separately. For example, for each field, the user is presented with a number of candidate values, corresponding to the different values seen in the duplicate records. A score is displayed for each candidate value, based on a score of a record feature that uses that candidate value. The user is prompted to select among the candidate values. Once the user has made such a selection for each field in which different candidate values are available, a resolved record is generated using the user selections.

Alternatively, the user can be presented with a plurality of generated records, along with scores based on feature vectors for those records, and prompted to select among the generated records.

In at least one embodiment, the user can be presented with multiple options when several solutions have similar scores. In at least one embodiment, the user can be prompted to provide reasons for the choice; as described above, such reasons can be useful for further training of ML model(s) 112.

In at least one embodiment, the system can also record timing information (such as, for example, the duration of the user's decision-making) as a measure to estimate the confidence of user labeling.

In at least one embodiment, the system can use A-B testing or some other form of validation to make a quantified estimate of the reliability of manual labeling.

### EXAMPLE

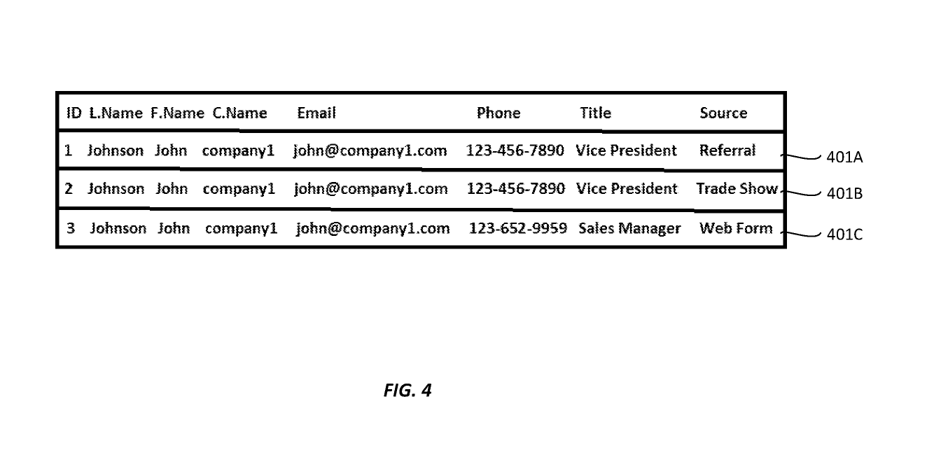

Referring now to FIG. 4, there is shown an example of a set of duplicated records 401A, 401B, 401C, that can be processed and resolved according to the techniques of the present invention. In this example, last name, first name, company name, and email address is consistent among all records 401. However, record 401C has a different phone number and title than do records 401A, 401B. Also indicated for each record 401 is the source of the record (referral, trade show, or web form).

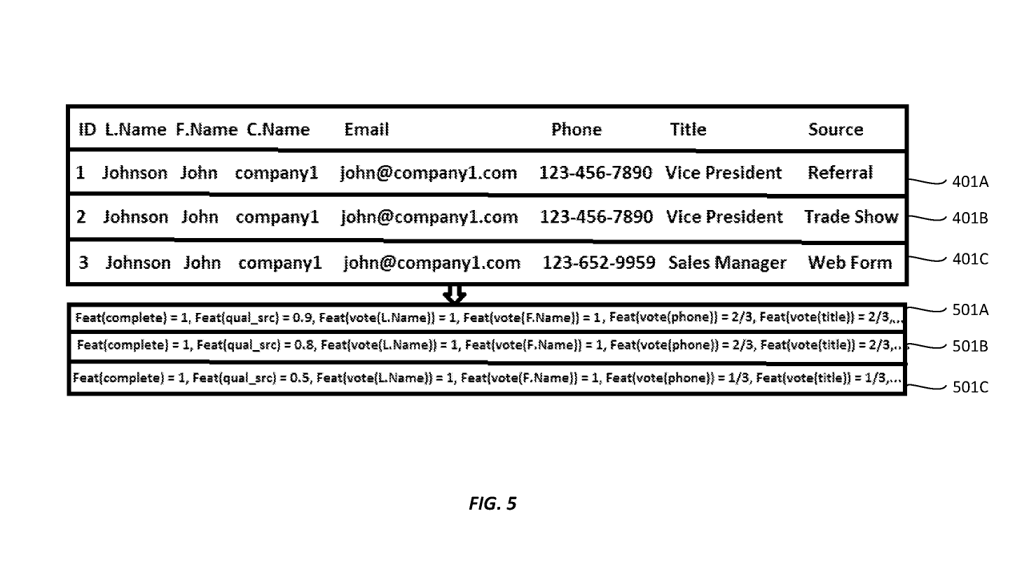

Referring now to FIG. 5, there is shown an example of a set of feature vectors 501A, 501B, 501C, that may be calculated from duplicated records 401A, 401B, 401C, respectively, according to one embodiment of the present invention. In this example, each feature vector 502 contains the following features (among others):
Completeness: all records have a value of 1;
Source quality: record 401A is given a value of 0.9 (referral source), record 401B a value of 0.8 (trade show), and record 401C a value of 0.5 (web form), reflecting the relative quality of these sources;
Voting: for the last name and first name fields, all records are given a value of 1, since they all agree with one another; for the phone and title fields, the values are ⅔ for records 401A and 401B, and ⅓ for record 401C, to reflect the fact that records 401A and 401B agree with one another, while record 401C does not agree with the other two.

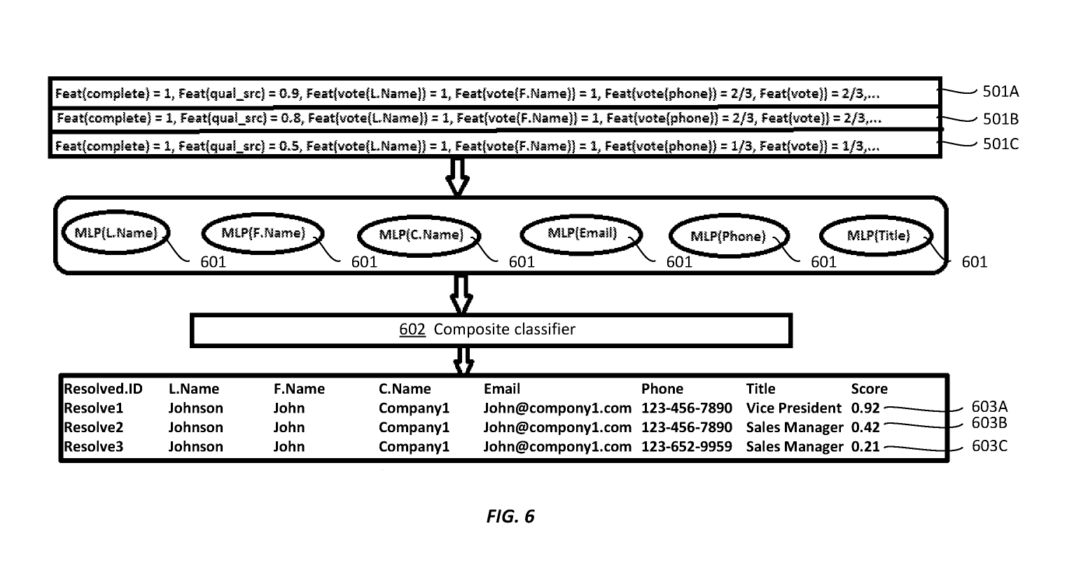

Referring now to FIG. 6, there is shown an example of generating resolved records from feature vectors 501, according to one embodiment of the present invention. Feature vectors 501A, 501B, 501C are fed into multilayer perceptrons (MLP's) 601, which are base classifiers as described above. In this example, an MLP 601 is provided for each field. Composite classifier 602 (such as HBS or MOR, or some other composite classifier) is used to combine the output of MLP's 601 and to generate resolved records 603A, 603B, 603C with confidence scores.

In this example, resolved record 603A (which uses the phone number and title from records 401A and 401B) has a confidence score of 0.92, while resolved record 603B (which uses the phone number from records 401A and 401B, but the title from record 401C) has a confidence score of 0.42, and resolved record 603C (which uses the phone number from record 401C) has a confidence score of 0.21. The higher-confidence resolved record 603A can be automatically selected, or all three records 603A, 603B, 603C can be presented to the user for selection.

### Variations

### Localization

In various embodiments, any number of other factors can be considered if the system is to be deployed for different locales, such as different countries for international audiences. The following are some illustrative examples:
Different conventions for names, addresses, phone numbers, and the like;
Different frequency tables for first names, last names, nicknames, and the like;
Locally based etymology can be used to determine whether or not two different names are likely to be duplicates;
For some locales having a visual written language (such as those using logographic writing systems), the system may use the actual appearance of writings in order to determine similarity with two items.

Localization may be extended to include more detailed granularity, such as handling different regions within a country, or different ZIP/area codes, and/or the like, separately from one another.

Adaptation by Training with Added Training Data

In the above-described method, classifiers can be first trained using existing historical data. However, in at least one embodiment, new data can also be used for training. For example, as new duplicated data and resolved records are added or generated, this new data can be applied to adaptively train classifiers to further improve performance. In this manner, the system of the present invention can continue to adapt, learn, and improve its performance over time.

One skilled in the art will recognize that the examples depicted and described herein are merely illustrative, and that other arrangements of user interface elements can be used. In addition, some of the depicted elements can be omitted or changed, and additional elements depicted, without departing from the essential characteristics of the invention.

The present invention has been described in particular detail with respect to possible embodiments. Those of skill in the art will appreciate that the invention may be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, or entirely in hardware elements, or entirely in software elements. Also, the particular division of functionality between the various system components described herein is merely exemplary, and not mandatory; functions performed by a single system component may instead be performed by multiple components, and functions performed by multiple components may instead be performed by a single component.

Reference in the specification to “one embodiment” or to “an embodiment” means that a particular feature, structure, or characteristic described in connection with the embodiments is included in at least one embodiment of the invention. The appearances of the phrases “in one embodiment” or “in at least one embodiment” in various places in the specification are not necessarily all referring to the same embodiment.

In various embodiments, the present invention can be implemented as a system or a method for performing the above-described techniques, either singly or in any combination. In another embodiment, the present invention can be implemented as a computer program product comprising a non-transitory computer-readable storage medium and computer program code, encoded on the medium, for causing a processor in a computing device or other electronic device to perform the above-described techniques.

Some portions of the above are presented in terms of algorithms and symbolic representations of operations on data bits within a memory of a computing device. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “displaying” or “determining” or the like, refer to the action and processes of a computer system, or similar electronic computing module and/or device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention can be embodied in software, firmware and/or hardware, and when embodied in software, can be downloaded to reside on and be operated from different platforms used by a variety of operating systems.

The present invention also relates to an apparatus for performing the operations herein. This apparatus may be specially constructed for the required purposes, or it may comprise a general-purpose computing device selectively activated or reconfigured by a computer program stored in the computing device. Such a computer program may be stored in a computer readable storage medium, such as, but is not limited to, any type of disk including floppy disks, optical disks, CD-ROMs, DVD-ROMs, magnetic-optical disks, read-only memories (ROMs), random access memories (RAMs), EPROMs, EEPROMs, flash memory, solid state drives, magnetic or optical cards, application specific integrated circuits (ASICs), or any type of media suitable for storing electronic instructions, and each coupled to a computer system bus. Further, the computing devices referred to herein may include a single processor or may be architectures employing multiple processor designs for increased computing capability.

The algorithms and displays presented herein are not inherently related to any particular computing device, virtualized system, or other apparatus. Various general-purpose systems may also be used with programs in accordance with the teachings herein, or it may prove convenient to construct more specialized apparatus to perform the required method steps. The required structure for a variety of these systems will be apparent from the description provided herein. In addition, the present invention is not described with reference to any particular programming language. It will be appreciated that a variety of programming languages may be used to implement the teachings of the present invention as described herein, and any references above to specific languages are provided for disclosure of enablement and best mode of the present invention.

Accordingly, in various embodiments, the present invention can be implemented as software, hardware, and/or other elements for controlling a computer system, computing device, or other electronic device, or any combination or plurality thereof. Such an electronic device can include, for example, a processor, an input device (such as a keyboard, mouse, touchpad, trackpad, joystick, trackball, microphone, and/or any combination thereof), an output device (such as a screen, speaker, and/or the like), memory, long-term storage (such as magnetic storage, optical storage, and/or the like), and/or network connectivity, according to techniques that are well known in the art. Such an electronic device may be portable or non-portable. Examples of electronic devices that may be used for implementing the invention include: a mobile phone, personal digital assistant, smartphone, kiosk, server computer, enterprise computing device, desktop computer, laptop computer, tablet computer, consumer electronic device, or the like. An electronic device for implementing the present invention may use any operating system such as, for example and without limitation: Linux; Microsoft Windows, available from Microsoft Corporation of Redmond, Wash.; Mac OS X, available from Apple Inc. of Cupertino, Calif.; iOS, available from Apple Inc. of Cupertino, Calif.; Android, available from Google, Inc. of Mountain View, Calif.; and/or any other operating system that is adapted for use on the device.

While the invention has been described with respect to a limited number of embodiments, those skilled in the art, having benefit of the above description, will appreciate that other embodiments may be devised which do not depart from the scope of the present invention as described herein. In addition, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the claims.

What is claimed is:

1. A computer-implemented method for resolving duplicate records using machine learning, comprising:
receiving a plurality of records previously identified as being duplicate records representing the same entity, wherein at least a subset of the duplicate records comprise conflicting data for the entity;
at a processor, generating a plurality of feature vectors, each feature vector comprising a plurality of features describing characteristics indicative of reliability of one of the records;
applying at least one machine learning model to the feature vectors to generate at least one resolved record by resolving the conflicting data as a plurality of multiple interdependent outputs;
outputting the at least one resolved record at an output device;
receiving user input indicating a level of confidence in the at least one resolved record; and
applying the received user input to refine the machine learning model.

2. The method of claim 1, wherein resolving the conflicting data as a plurality of multiple interdependent outputs comprises applying hierarchical-based sequencing to the feature vectors.

3. The method of claim 1, wherein resolving the conflicting data as a plurality of multiple interdependent outputs comprises applying iterated multiple output relaxation to the feature vectors.

4. The method of claim 1, wherein applying at least one machine learning model to the feature vectors to generate at least one resolved record comprises:
applying at least one machine learning model to the feature vectors to generate a plurality of resolved records.

5. The method of claim 4, wherein receiving user input indicating a level of confidence in the at least one resolved record comprises receiving user input specifying a confidence score for each of the resolved records.

6. The method of claim 4, wherein receiving user input indicating a level of confidence in the at least one resolved record comprises receiving user input to select one of the resolved records.

7. The method of claim 1, wherein each feature vector comprises at least one selected from the group consisting of:
a descriptor of record completeness;
a descriptor of quality of record source;
an indicator of field validity;
a voting score indicating relative frequency of a particular field value among the plurality of duplicate records;
a frequency score indicating how often a particular data value appears in a frequency table;
a recency score indicating how recently a field was updated; and
an internal consistency score indicating how consistent a given field is with other fields.

8. The method of claim 1, further comprising:
generating a centroid record from the plurality of duplicate records, wherein the centroid record has minimized overall distance to all of the duplicate records;
and wherein at least one feature comprises a degree of similarity of a record to the centroid record.

9. The method of claim 1, further comprising, prior to receiving a plurality of duplicate records representing the same entity, training the at least one machine learning model using training data.

10. The method of claim 9, wherein training the at least one machine learning model comprises training the at least one machine learning model using at least one of:
historical records; and
rule-based labeling.

11. The method of claim 1, wherein receiving user input indicating a level of confidence in the at least one resolved record comprises receiving a plurality of user-labeled records comprising confidence scores;
and wherein applying the received user input to refine the machine learning model comprises:
applying an instance-weighted learning algorithm to weight the user-labeled records based on the confidence scores; and
refining the at least one machine learning model using the weighted user-labeled records.

12. The method of claim 1, wherein applying at least one machine learning model to the feature vectors comprises applying a plurality of machine learning models to the feature vectors.

13. The method of claim 1, wherein applying at least one machine learning model to the feature vectors comprises:
applying a sequence of base classifiers to the feature vectors, to generate predictions; and
combining the predictions generated by the base classifiers.

14. The method of claim 13, wherein each base classifier comprises a multilayer perceptron.

15. The method of claim 13, wherein combining the predictions generated by the base classifiers comprises applying a composite classifier to the output of the base classifiers.

16. The method of claim 15, wherein the composite classifier comprises a machine learning model that uses hierarchical based sequencing to select a sequence for output components of the base classifiers.

17. The method of claim 15, wherein the composite classifier comprises a machine learning model that uses iterated multiple output relaxation to perform a series of relaxation iterations to update output values until a trigger event has occurred;
wherein the trigger event comprises at least one of:
a relaxation state reaching an equilibrium; and
a pre-defined number of relaxation iterations having taken place.

18. The method of claim 1, wherein the at least one resolved record comprises at least one data element from each of at least two different received duplicate records.

19. A computer-implemented method for resolving duplicate records using machine learning, comprising:
receiving a plurality of records previously identified as being duplicate records representing the same entity, wherein at least a subset of the duplicate records comprise conflicting data for the entity, each duplicate record comprising values for a plurality of data fields;
at a processor, generating a plurality of feature vectors, each feature vector comprising a plurality of features describing characteristics indicative of reliability of one of the records;
applying at least one machine learning model to the feature vectors to generate scores for the feature vectors by resolving the conflicting data as a plurality of multiple interdependent outputs;
for each of at least a subset of the data fields:
displaying, at an output device, a plurality of values, each value corresponding to at least one of the duplicate records; and
for each displayed value, displaying, at the output device, a score for a feature vector generated using the displayed value;
receiving, at an input device, user input selecting one of the displayed values; and
applying the received user input to refine the machine learning model.

20. The method of claim 19, wherein resolving the conflicting data as a plurality of multiple interdependent outputs comprises applying hierarchical-based sequencing to the feature vectors.

21. The method of claim 19, wherein resolving the conflicting data as a plurality of multiple interdependent outputs comprises applying iterated multiple output relaxation to the feature vectors.

22. The method of claim 19, further comprising:
assembling a resolved record from the user-selected values.

23. A non-transitory computer-readable medium for resolving duplicate records using machine learning, comprising instructions stored thereon, that when executed by a processor, perform the steps of:
receiving a plurality of records previously identified as being duplicate records representing the same entity, wherein at least a subset of the duplicate records comprise conflicting data for the entity;
generating a plurality of feature vectors, each feature vector comprising a plurality of features describing characteristics indicative of reliability of one of the records;
applying at least one machine learning model to the feature vectors to generate at least one resolved record by resolving the conflicting data as a plurality of multiple interdependent outputs;
causing an output device to output the at least one resolved record;
causing an input device to be receptive to user input indicating a level of confidence in the at least one resolved record; and
applying the received user input to refine the machine learning model.

24. The non-transitory computer-readable medium of claim 23, wherein resolving the conflicting data as a plurality of multiple interdependent outputs comprises applying hierarchical-based sequencing to the feature vectors.

25. The non-transitory computer-readable medium of claim 23, wherein resolving the conflicting data as a plurality of multiple interdependent outputs comprises applying iterated multiple output relaxation to the feature vectors.

26. The non-transitory computer-readable medium of claim 23, wherein:
apply at least one machine learning model to the feature vectors to generate at least one resolved record comprises applying at least one machine learning model to the feature vectors to generate a plurality of resolved records; and
causing an input device to be receptive to user input indicating a level of confidence in the at least one resolved record comprises causing an input device to be receptive to user input to select one of the resolved records.

27. The non-transitory computer-readable medium of claim 21, wherein each feature vector comprises at least one selected from the group consisting of:
a descriptor of record completeness;
a descriptor of quality of record source;
an indicator of field validity;
a voting score indicating relative frequency of a particular field value among the plurality of duplicate records;
a frequency score indicating how often a particular data value appears in a frequency table;
a recency score indicating how recently a field was updated; and
an internal consistency score indicating how consistent a given field is with other fields.

28. The non-transitory computer-readable medium of claim 27, further comprising instructions stored thereon, that when executed by a processor, perform the steps of, prior to receiving a plurality of duplicate records representing the same entity, training the at least one machine learning model using training data.

29. The non-transitory computer-readable medium of claim 27, wherein applying at least one machine learning model to the feature vectors comprises:
applying a sequence of multilayer perceptrons to the feature vectors, to generate predictions; and
combining the predictions generated by the multilayer perceptrons by applying a composite classifier to the output of the multilayer perceptrons.

30. The non-transitory computer-readable medium of claim 27, wherein the at least one resolved record comprises at least one data element from each of at least two different received duplicate records.

31. A system for resolving duplicate records using machine learning, comprising:
a processor, configured to:
receive a plurality of records previously identified as being duplicate records representing the same entity, wherein at least a subset of the duplicate records comprise conflicting data for the entity;
generate a plurality of feature vectors, each feature vector comprising a plurality of features describing characteristics indicative of reliability of one of the records; and
apply at least one machine learning model to the feature vectors to generate at least one resolved record by resolving the conflicting data as a plurality of multiple interdependent outputs;
an output device, communicatively coupled to the processor, configured to output the at least one resolved record; and
an input device, communicatively coupled to the processor, configured to receive user input indicating a level of confidence in the at least one resolved record;
wherein the processor is further configured to apply the received user input to refine the machine learning model.

32. The system of claim 31, wherein the processor is configured to resolve the conflicting data as a plurality of multiple interdependent outputs by applying hierarchical-based sequencing to the feature vectors.

33. The system of claim 31, wherein the processor is configured to resolve the conflicting data as a plurality of multiple interdependent outputs by applying iterated multiple output relaxation to the feature vectors.

34. The system of claim 31, wherein the processor is configured to apply at least one machine learning model to the feature vectors by applying at least one machine learning model to the feature vectors to generate a plurality of resolved records.

35. The system of claim 31, wherein each feature vector comprises at least one selected from the group consisting of:
a descriptor of record completeness;
a descriptor of quality of record source;
an indicator of field validity;
a voting score indicating relative frequency of a particular field value among the plurality of duplicate records;
a frequency score indicating how often a particular data value appears in a frequency table;
a recency score indicating how recently a field was updated; and
an internal consistency score indicating how consistent a given field is with other fields.

36. The system of claim 31, wherein the processor is further configured to, prior to receiving a plurality of duplicate records representing the same entity, train the at least one machine learning model using training data.

37. The system of claim 31, wherein the processor is configured to apply at least one machine learning model to the feature vectors by:
applying a sequence of multilayer perceptrons to the feature vectors, to generate predictions; and
combining the predictions generated by the multilayer perceptrons by applying a composite classifier to the output of the multilayer perceptrons.

38. The system of claim 31, wherein the at least one resolved record comprises at least one data element from each of at least two different received duplicate records.
